(19) United States
(12) Patent Application Publication
(10) Pub. No.: US 2023/0278671 A1
(43) Pub. Date: Sep. 7, 2023

(54) LIQUID CONTAINER

(71) Applicant: MIKUNI CORPORATION, Tokyo (JP)

(72) Inventor: Takumi OIKAWA, Odawara-shi (JP)

(73) Assignee: MIKUNI CORPORATION, Tokyo (JP)

(21) Appl. No.: 18/173,497

(22) Filed: Feb. 23, 2023

(30) Foreign Application Priority Data
Mar. 1, 2022 (JP) 2022-030606

(51) Int. Cl. B63B 17/00; B63H 21/38; F02M 37/00

(52) U.S. Cl. CPC B63B 17/0027; B63H 21/38; F02M 37/0023; B60K 2015/03473

(57) ABSTRACT

A liquid container according to the present invention includes: a container 2 temporarily storing a fuel; and a drain unit 3 discharging the fuel from a communication hole 11 provided at a lower portion of the container 2, and the drain unit 3 includes a valve body 15 formed of metal with higher strength and hardness than those of the container 2 made of resin, including a drain passage establishing communication between the communication hole 11 and outside and a valve seat facing the drain passage, which are formed therein, and detachably fixed to the container 2, and a drain screw 16 having a valve element attached to the valve body 15 for opening and closing the drain passage by being separated from or abutting the valve seat.

### BACKGROUND OF THE INVENTION

### Field of the Invention

The present invention relates to a structure of a drain device for a liquid container for storing liquid.

### Description of the Related Art

An internal combustion engine for a ship includes a vapor separating tank in a fuel system. The vapor separating tank is included in a fuel supply path between a fuel tank and the internal combustion engine and has a function of temporarily storing a fuel and distinguishing and discharging gas such as air bubbles in the fuel. Also, the vapor separating tank includes a drain device for discharging the fuel in a case where the combustion engine is not used for a long period of time during maintenance or off season.

For example, Japanese Patent Laid-Open No. 2019-44604 discloses a drain device included in a container made of resin for storing a fuel, such as a vapor separating tank. The drain device in Japanese Patent Laid-Open No. 2019-44604 has a configuration of sealing a drain passage by pushing a drain valve screw including a valve element at a distal end portion thereof into the drain passage that is formed at a lower portion of the container and discharges the fuel from the container.

However, Japanese Patent Laid-Open No. 2019-44604 adopts a relatively complicated configuration using a plurality of O rings or collars at the sealing portion of the drain device to prevent fuel leakage at the time of the sealing of the drain passage in the container made of resin. Also, according to the structure of sealing the drain passage by tightly closing the drain valve with respect to the container made of resin, there is a concern that the container near the drain passage may break if the drain valve is tightened with an unnecessarily large force to reliably seal the drain passage.

Additionally, there is a problem that if a part of the container breaks in this manner, the entire container has to be replaced, and it may lead to an increase in repair cost.

The present invention is made in view of such problems, and an object thereof is to provide a liquid container that enables a drain device for discharging a stored liquid to be configured with a simple structure, enables an improvement in sealing performance and breakage prevention performance, and enables repair cost to be reduced even at the time of breakage of the drain device.

### SUMMARY OF THE INVENTION

In order to achieve the above object, a liquid container according to the present invention includes: a container main body storing a liquid; and a drain unit discharging the liquid from a communication hole provided in the container main body, and the drain unit includes a valve body formed of a material with higher strength and hardness than those of the container main body, including a drain passage establishing communication between the communication hole and outside and a valve seat facing the drain passage therein, and detachably fixed to the container main body, and a drain screw having a valve element attached to the valve body for opening and closing the drain passage by being separated from or abutting the valve seat.

Preferably, the container main body is formed of resin, and the valve body is formed of metal.

Preferably, the valve body includes a valve body main body portion including the valve seat therein, and a container connecting portion having one end connected to the valve body main body portion and another end projecting outward from the valve body main body portion and inserted into the communication hole in the container main body, the container connecting portion establishing communication of the drain passage from the container main body to inside of the valve body main body portion.

Preferably, the valve body main body portion is fastened to the container main body with a fixing screw, and a fastening direction of the fixing screw is the same as an insertion direction of the container connecting portion into the container main body.

Preferably, the valve body further includes a valve body main body portion including the valve seat, and a drain nipple having one end connected on a downstream side of the valve element of the drain passage of the valve body main body portion and another end projecting outward from the valve body such that a hose is able to be connected to a distal end portion of the another end.

Preferably, the liquid container is a vapor separating tank separating gas from a fuel for an internal combustion engine.

According to the liquid container of the present invention, the valve body of the drain unit opening and closing the drain passage for discharging the liquid from the container main body to the outside has higher strength and hardness than the container main body, and it is thus possible to curb breakage of the valve body and to improve sealability of the valve body.

Also, since the valve body is detachably fixed to the container main body, repair is completed by replacing the valve body even if the valve body causes breakage or a failure, there is no need to replace the container main body, and it is possible to reduce repair cost.

### BRIEF DESCRIPTION OF THE DRAWINGS

FIG. 1 is a front view of a vapor separating tank according to an embodiment of the present invention;

FIG. 2 is a side view of the vapor separating tank according to the present embodiment;

FIG. 3 is a lower view of the vapor separating tank according to the present embodiment;

FIG. 4 is a vertical sectional view of the vapor separating tank; and

FIG. 5 is a horizontal sectional view of a drain unit portion of the vapor separating tank.

### DETAILED DESCRIPTION OF THE INVENTION

Hereinafter, an embodiment of the present invention will be described on the basis of the drawings.

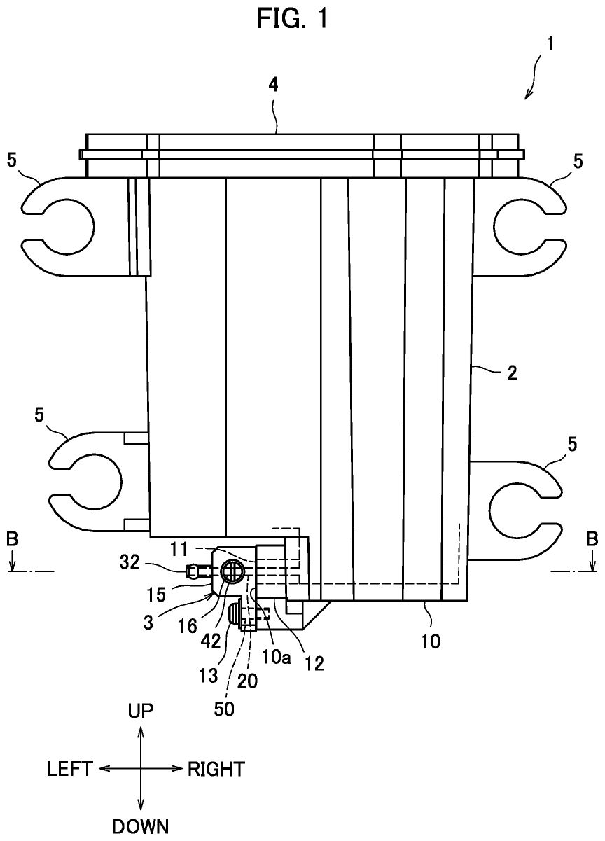

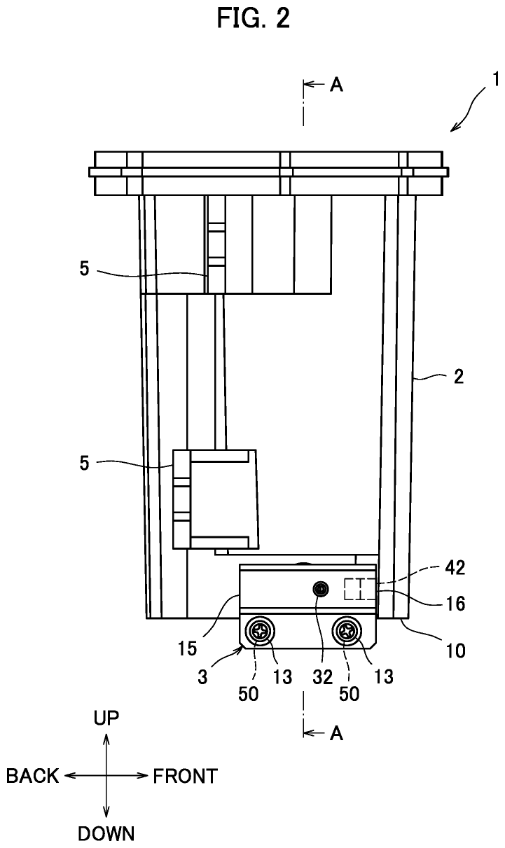

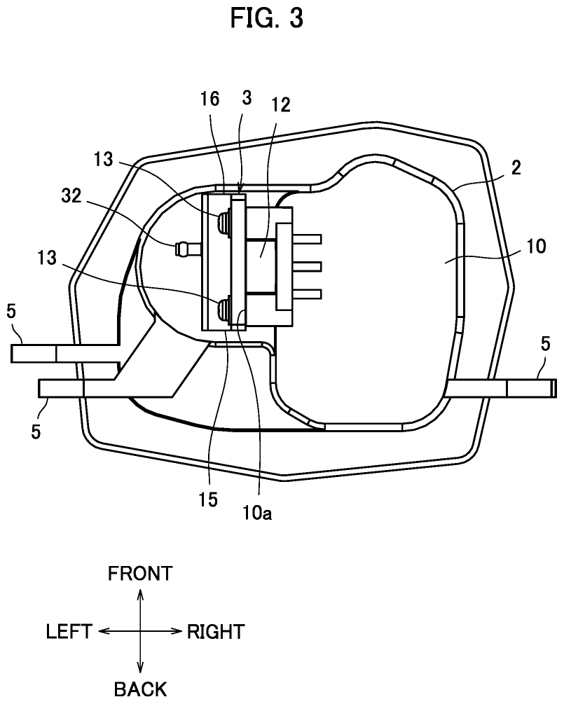

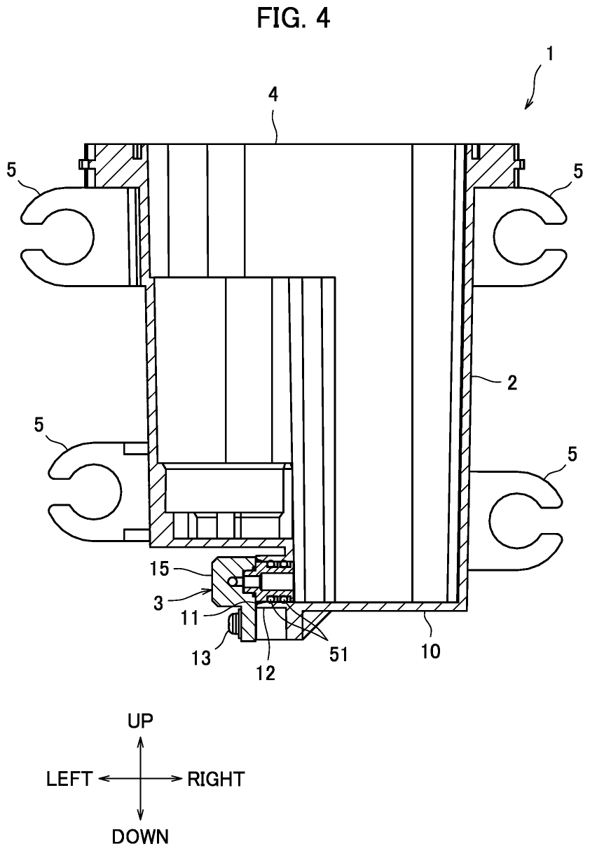

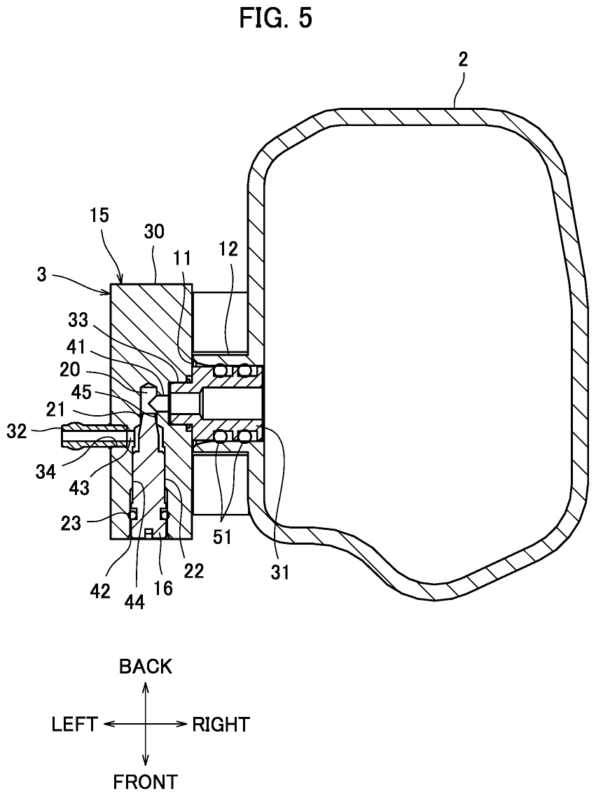

FIG. 1 to FIG. 3 are appearance views of a vapor separating tank which is a liquid container according to an embodiment of the present invention. FIG. 1 is a front view, FIG. 2 is a side view, and FIG. 3 is a bottom view. FIG. 4 is a vertical sectional view of the vapor separating tank. Note that FIG. 4 is a sectional view of the A-A part illustrated in FIG. 2. FIG. 5 is a horizontal sectional view of a lower portion of the vapor separating tank. Note that FIG. 5 is an enlarged sectional view of the B-B part illustrated in FIG. 1. Note that the following description will be given by using the front, back, left, right, up, and down directions illustrated in FIG. 1.

A vapor separating tank 1 according to an embodiment of the present invention is included in a fuel system for an internal combustion engine mounted in a ship or the like. The vapor separating tank 1 is included in a fuel pipe between a fuel tank and the internal combustion engine and has a function of temporarily storing a fuel and separating gas such as evaporated gas and air bubbles in the fuel.

<Structure of Vapor Separating Tank>

As illustrated in FIGS. 1 to 5, the vapor separating tank 1 includes a container 2 (container main body) formed of resin and storing a fuel and a drain unit 3. The drain unit 3 is an opening/closing valve that opens and closes a drain passage 20 for discharging the fuel remaining in the container 2 of the vapor separating tank 1. In a case where the internal combustion engine is not used for a long period of time during maintenance or season off, supply of a fuel left in the vapor separating tank 1 for a long period of time and degraded to the internal combustion engine at the time of next activation of the internal combustion engine is curbed by opening the drain unit 3 and discharging the fuel from the inside of the container 2.

The container 2 is a substantially rectangular box-shaped container having an internal space for storing the fuel therein. An opening portion 4 is provided at an upper portion, and the opening portion 4 is covered with a lid, which is not illustrated, such that the inside is tightly closed. The fuel is supplied from the fuel tank of the internal combustion engine to the inside of the container 2 via a pipe provided in the lid, which is not illustrated. The fuel is temporarily stored in the container 2, and gas such as evaporated gas and air bubbles in the fuel is separated. Also, the liquid fuel is supplied from the inside of the container 2 to the internal combustion engine via the pipe provided in the lid, which is not illustrated, and gas is discharged from a vapor discharge port provided in the lid, which is not illustrated. The gas-liquid separation structure in the vapor separating tank 1 is known as described in Japanese Patent Laid-Open No. 2019-44604, for example, and description thereof will thus be omitted.

Note that a plurality of brackets 5 for fixing the container are integrally formed in the container 2 according to the present embodiment.

A bottom portion 10 projecting downward is included at a right side part of the lower portion of the container 2. The bottom portion 10 is provided with a communication hole 11 for drain discharge that establishes communication between the internal space of the container 2 and the outside. The communication hole 11 is a circular hole that is provided in a projecting portion 12 projecting leftward in a cylindrical shape from a left side wall 10a of the bottom portion 10 of the container 2 and that is opened to face the left side.

The drain unit 3 is fixed to the lower portion of the container 2 and the left side wall 10a of the bottom portion 10 with two fixing screws 13 with the communication hole 11 covered therewith.

<Structure of Drain Unit>

The drain unit 3 includes a valve body 15 and a drain screw 16.

The valve body 15 includes a drain passage 20 for discharging the fuel from the communication hole 11 in the container to the outside therein.

The drain screw 16 is disposed to be inserted into the valve body 15 and has a function of opening and closing the drain passage 20 in the valve body 15. A valve element 21 is included at a distal end portion of the drain screw 16, and a male screw portion 22 is formed at a base portion. A groove is formed at a head portion of the drain screw 16 such that the drain screw 16 can be rotated by a tool such as a driver. A groove for an O ring is formed at an end portion of the male screw portion 22 of the drain screw 16, and an O ring 23 is attached to the groove.

The valve body 15 includes a rectangular block-shaped valve body main body portion 30, a cylindrical container connecting portion 31 that is inserted into the communication hole 11 of the container, and a drain nipple 32 which has a thin cylindrical rod shape and allows a drain hose to be connected thereto. All the valve body main body portion 30, the container connecting portion 31, and the drain nipple 32 are formed of metal such as stainless steel or brass.

A recessed portion 33 into which one end portion of the container connecting portion 31 is inserted is formed in a right side surface of the valve body main body portion 30. Also, a recessed portion 34 into which a base portion of the drain nipple 32 is inserted is formed in a left side surface of the valve body main body portion 30. The container connecting portion 31 and the drain nipple 32 are press-fitted into the recessed portions 33 and 34 of the valve body main body portion 30 and are fixed to the valve body main body portion 30 through brazing, for example.

The drain passage 20 formed in the valve body main body portion 30 is configured to establish communication between the inside of the recessed portion 33 in the right side surface and the inside of the recessed portion 34 in the left side surface. Additionally, the container connecting portion 31 and the drain nipple 32 are disposed at positions offset in the front-back direction. The drain passage 20 extends slightly leftward from the side of the recessed portion 33 inside the valve body main body portion 30, is vertically bent forward, extends forward by about several centimeters, is further vertically bent on the left side, and is opened inside the recessed portion 34 into which the drain nipple 32 is inserted. The drain screw 16 is inserted from the front side into the hole extending in the front-back direction of the drain passage 20 inside the valve body main body portion 30, and an opening/closing valve is thereby formed.

In a case where the drain passage 20 is formed inside the valve body main body portion 30, a drain screw insertion hole 42 is pierced from the front surface of the valve body main body portion 30 toward the back side up to the substantially center portion in the front-back direction by using a lathe, an upstream side hole 41 is pierced to establish communication with the drain screw insertion hole 42 from the right side surface of the valve body main body portion 30, and a downstream side hole 43 is pierced to establish communication with the drain screw insertion hole 42 from the left side surface of the valve body main body portion 30. Note that the upstream side hole 41 is located coaxially with the recessed portion 33 for the container connecting portion 31, and the downstream side hole 43 is located coaxially with the recessed portion 34 for insertion of the drain nipple 32. Note that it is only necessary to form the recessed portion 33 for insertion of the container connecting portion 31 and the recessed portion 34 for insertion of the drain nipple 32 with the lathe or the like by using the upstream side hole 41 and the downstream side hole 43 as prepared holes after opening them.

A female screw portion 44 into which the male screw portion 22 of the drain screw 16 is screwed may be formed at an intermediate portion of the drain screw insertion hole 42. Also, a valve seat 45 that abuts the valve element 21 at the distal end portion of the drain screw 16 is formed between the upstream side hole 41 and the downstream side hole 43 at a deep portion of the drain screw insertion hole 42.

Once the drain screw 16 is loosened and moved forward relative to the valve body main body portion 30, and the valve element 21 of the drain screw 16 and the valve seat 45 inside the valve body main body portion 30 are separated, the upstream side hole 41, the drain screw insertion hole 42, and the downstream side hole 43 establish communication, and the drain passage 20 thus establishes communication from the container connecting portion 31 to the drain nipple 32.

Once the drain screw 16 is screwed into the valve body main body portion 30, and the valve element 21 of the drain screw 16 and the valve seat 45 inside the valve body main body portion 30 abut each other, the drain screw insertion hole 42 is blocked by the abutting portion in this configuration. In this manner, the drain passage 20 from the container connecting portion 31 to the drain nipple 32 is interrupted in the valve body main body portion 30.

Screw fastening holes 50 extending in the left-right direction and allowing fixing screws 13 to be inserted thereinto are formed in the valve body main body portion 30. Two screw fastening holes 50 are provided to be located below the drain screw insertion hole 42 and to be separated from each other in the front-back direction.

On the other hand, female screws allowing the fixing screws 13 to be fastened thereinto are formed at two locations at the lower portion of the bottom portion 10 of the container 2. The valve body main body portion 30 is fastened to the container 2 with the two fixing screws 13. The drain unit 3 is thus fixed to the container 2. At this time, the distal end portion of the container connecting portion 31 of the valve body 15 is inserted into the communication hole 11 in the container 2, and the drain unit 3 is fixed to be pressed against the left side wall 10a of the bottom portion 10 of the container 2. Grooves for attaching O rings 51 are provided at two locations in the outer circumferential surface of the container connecting portion 31, and the O rings 51 are attached to the grooves. When the drain unit 3 is fixed to the container 2, and the distal end portion of the container connecting portion 31 is inserted into the communication hole 11, the O ring 51 prevents fuel leakage at the insertion portion of the container connecting portion 31 into the communication hole 11.

### Advantages

As described above, the vapor separating tank 1 according to the present embodiment includes the container 2 made of resin and the drain unit 3. It is possible to reduce the weight of the vapor separating tank 1 by adopting the container 2 made of resin.

On the other hand, the valve body 15 of the drain unit 3 is formed of metal and has higher strength than the container 2, and it is thus possible to prevent breakage of the valve body 15 even if the drain screw 16 is strongly tightened to block the drain passage 20, for example. Also, since the valve body 15 of the drain unit 3 has higher hardness than the container 2, it is possible to enhance adhesion between the valve seat 45 of the valve body 15 and the valve element 21 of the drain screw 16 when the drain screw 16 is closed and to improve sealability of the drain passage 20 when the drain unit 3 is closed.

Also, since the valve body 15 is detachably fixed to the container 2 with the fixing screws 13, repair is simply completed by replacing the valve body 15 even if the valve body 15 causes breakage or a failure. In this manner, there is no need to replace the container 2, and it is possible to reduce repair cost of the vapor separating tank 1.

Furthermore, the valve body 15 is configured of the valve body main body portion 30 including the valve seat 45 therein, the container connecting portion 31 having one end connected to the valve body main body portion 30 and the other end projecting outward from the valve body main body portion 30, inserted into and connected to the communication hole of the container 2, and establishing communication of the drain passage 20 from the container 2 to the inside of the valve body main body portion 30, and the drain nipple 32. Also, the valve body 15 is formed by press-fitting the container connecting portion 31 and the drain nipple 32 into the valve body main body portion 30.

In this manner, it is possible to adopt each simple component structure by forming the valve body main body portion 30 into a rectangular block shape and forming the container connecting portion 31 and the drain nipple 32 into tubular shapes as in the present embodiment, for example. Therefore, it is possible to improve yields of the components and to reduce component cost as compared with a case where the valve body 15 is integrally formed with the valve body main body portion 30 and the drain nipple 32.

Additionally, it is possible to share the drain unit 3 even in a case where it is necessary for a manufacturer of the vapor separating tank 1 to manufacture the container 2 with a different capacity. Moreover, even in a case where the container 2 including the communication hole 11 with a different inner diameter is used, it is possible to share the valve body main body portion 30 by preparing the container connecting portion 31 with an outer diameter in accordance with the inner diameter of the communication hole 11 and using the container connecting portion 31 for the drain unit 3.

Also, in regard to the drain nipple 32 for drain discharge, it is possible to share the valve body main body portion 30 even in a case where it is necessary to manufacture the vapor separating tank 1 to which a hose with a different inner diameter is connected, by preparing and using the drain nipple 32 in accordance with the inner diameter of the hose.

In this manner, it is possible to manufacture various drain units 3 while reducing the number of components by using the shared valve body main body portion 30, the container connecting portion 31 in accordance with the inner diameter of the communication hole 11, and the drain nipple 32 in accordance with the inner diameter of the hose.

Also, the valve body main body portion 30 is fastened to the container 2 with the fixing screws 13, and the fastening direction of the fixing screws 13 is the same as the insertion direction of the container connecting portion 31 into the container 2. In this manner, the container connecting portion 31 is inserted into the container 2 by fastening and tightening the valve body main body portion 30 to the container 2 with the fixing screws 13. It is thus possible to reliably connect the container 2 to the container connecting portion 31.

Although the description of the embodiment is ended here, aspects of the present invention are not limited to the above embodiment. A detailed shape and structure of each component of the vapor separating tank 1 in the above embodiment may be different as needed.

For example, attachment directions and attachment positions of the container connecting portion 31, the drain screw 16, and the drain nipple 32 with respect to the valve body main body portion 30 in the above embodiment may be changed as needed.

Also, although the container 2 is formed of resin and the valve body 15 is formed of metal in the above embodiment, the present invention is not limited thereto, and it is only necessary for the valve body 15 to be formed of a material with higher strength and hardness than those of the container 2.

Also, although the above embodiment relates to the vapor separating tank 1 included in a fuel system for an internal combustion engine of a ship or the like, the present invention may be applied to a vapor separating tank used for other purposes.

Moreover, the present invention can be widely applied not only to the vapor separating tank but also to tanks for storing various kinds of liquid requiring the drain function.

### REFERENCE SIGNS LIST

1 vapor separating tank (liquid container)
2 container (container main body)
3 drain unit
11 communication hole
13 fixing screw
15 valve body
16 drain screw
20 drain passage
21 valve element
30 valve body main body portion
31 container connecting portion
32 drain nipple
45 valve seat

What is claimed is:

1. A liquid container comprising:
a container main body storing a liquid; and
a drain unit discharging the liquid from a communication hole provided in the container main body,
wherein the drain unit includes
a valve body formed of a material with higher strength and hardness than those of the container main body, including a drain passage establishing communication between the communication hole and outside and a valve seat facing the drain passage therein, and detachably fixed to the container main body, and
a drain screw having a valve element attached to the valve body for opening and closing the drain passage by being separated from or abutting the valve seat.

2. The liquid container according to claim 1,
wherein the container main body is formed of resin, and
the valve body is formed of metal.

3. The liquid container according to claim 1,
wherein the valve body includes
a valve body main body portion including the valve seat therein, and
a container connecting portion having one end connected to the valve body main body portion and another end projecting outward from the valve body main body portion and inserted into the communication hole in the container main body, the container connecting portion establishing communication of the drain passage from the container main body to inside of the valve body main body portion.

4. The liquid container according to claim 2,
wherein the valve body includes
a valve body main body portion including the valve seat therein, and
a container connecting portion having one end connected to the valve body main body portion and another end projecting outward from the valve body main body portion and inserted into the communication hole in the container main body, the container connecting portion establishing communication of the drain passage from the container main body to inside of the valve body main body portion.

5. The liquid container according to claim 3,
wherein the valve body main body portion is fastened to the container main body with a fixing screw, and
a fastening direction of the fixing screw is the same as an insertion direction of the container connecting portion into the container main body.

6. The liquid container according to claim 4,
wherein the valve body main body portion is fastened to the container main body with a fixing screw, and
a fastening direction of the fixing screw is the same as an insertion direction of the container connecting portion into the container main body.

7. The liquid container according to claim 1,
wherein the valve body further includes
a valve body main body portion including the valve seat, and
a drain nipple having one end connected on a downstream side of the valve element of the drain passage of the valve body main body portion and another end projecting outward from the valve body such that a hose is able to be connected to a distal end portion of the another end.

8. The liquid container according to claim 2,
wherein the valve body further includes
a valve body main body portion including the valve seat, and
a drain nipple having one end connected on a downstream side of the valve element of the drain passage of the valve body main body portion and another end projecting outward from the valve body such that a hose is able to be connected to a distal end portion of the another end.

9. The liquid container according to claim 3,
wherein the valve body further includes
a valve body main body portion including the valve seat, and
a drain nipple having one end connected on a downstream side of the valve element of the drain passage of the valve body main body portion and another end projecting outward from the valve body such that a hose is able to be connected to a distal end portion of the another end.

10. The liquid container according to claim 4,
wherein the valve body further includes
a valve body main body portion including the valve seat, and
a drain nipple having one end connected on a downstream side of the valve element of the drain passage of the valve body main body portion and another end projecting outward from the valve body such that a hose is able to be connected to a distal end portion of the another end.

11. The liquid container according to claim 5,
wherein the valve body further includes
a valve body main body portion including the valve seat, and
a drain nipple having one end connected on a downstream side of the valve element of the drain passage of the valve body main body portion and another end projecting outward from the valve body such that a hose is able to be connected to a distal end portion of the another end.

12. The liquid container according to claim 6,
wherein the valve body further includes
a valve body main body portion including the valve seat, and
a drain nipple having one end connected on a downstream side of the valve element of the drain passage of the valve body main body portion and another end projecting outward from the valve body such that a hose is able to be connected to a distal end portion of the another end.

13. The liquid container according to claim 1,
wherein the liquid container is a vapor separating tank separating gas from a fuel for an internal combustion engine.
